(19) United States
(12) Patent Application Publication
(10) Pub. No.: US 2002/0128358 A1
(43) Pub. Date: Sep. 12, 2002

(54) Transparent, flame-retardant, oriented film made from a crystallizable thermoplastic, its use and process for its production

(76) Inventors: Ursula Murschall, Nierstein (DE); Ulrich Kern, Ingelheim (DE); Guenther Crass, Taunusstein (DE); Andreas Stopp, Ingelheim (DE)

Correspondence Address: ProPat, L.L.C., Attention: Gregory N. Clements, 2912 Crosby Road, Charlotte, NC, 28211, US

(21) Appl. No.: 09/757,721

(22) Filed: Jan. 10, 2001

(51) Int. Cl. B32B 27/36; C08K 5/49

(52) U.S. Cl. 524/115; 264/173.16; 428/480

(57) ABSTRACT

The invention relates to a transparent, flame-retardant, oriented film made from a thermoplastic and whose thickness is from 5 to 300 μm. The film comprises at least one flame retardant and has very good optical and mechanical properties, and also has good orientability and can be produced cost-effectively. The invention further relates to the use of this film and to a process for its production.

The invention relates to a transparent, flame-retardant, oriented film made from a thermoplastic and whose thickness is from 5 to 300 μm. The film comprises at least one flame retardant and has very good optical and mechanical properties and good orientability, and can be produced cost-effectively. The invention further relates to the use of this film and to a process for its production.

### BACKGROUND OF THE INVENTION

Transparent films made from crystallizable thermoplastics of thickness between 5 and 300 μm are well known.

These films are not flame-retardant. For this reason, neither the films nor the items produced from them are suitable for applications where fire protection or low flammability is a requirement.

DE-A 23 46 787 describes a low-flammability polymer. Besides the polymer, the use of the polymer to give films and fibers is also described. However, when films were produced from the phospholane-modified polymer described in said publication the following shortcomings were apparent:

The polymer is very susceptible to hydrolysis and has to be very thoroughly predried. When the polymer is dried using dryers of the prior art it cakes, and production of a film is possible only under very difficult conditions.

The films produced under extreme, and uneconomic, conditions embrittle at high temperatures, that is to say their mechanical properties decline sharply as a result of embrittlement, making the film unusable. This embrittlement arises after as little as 48 hours at high temperature.

### DESCRIPTION OF THE INVENTION

The object of the present invention was to provide a transparent, flame-retardant, oriented film having a thickness of from 5 to 300 μm which can be produced cost-effectively, can readily be oriented, has good mechanical and optical properties, and above all is flame-retardant and does not embrittle at high temperatures.

For the purposes of the present invention, flame retardancy means that the transparent film complies with the conditions of DIN 4102 Part 2 and in particular the conditions of DIN 4102 Part 1 in tests known as fire-protection tests, and can be assigned to construction materials class B2, and in particular B1, for low-flammability materials. The film should also pass the UL 94 “Vertical Burning Test for Flammability of Plastic Material”, so that it can be placed in class 94 VTM-0. This means that the film is no longer burning 10 seconds after removal of a Bunsen burner, and that after 30 seconds there is no smouldering, and also that there are no drops of burning material.

Examples of the good optical properties required are high luminous transmittance (>80%), high surface gloss (>100), low haze (<20%), and also a low Yellowness Index (YID<10).

The good mechanical properties include, inter alia, a high modulus of elasticity (EMD>3200 N/mm2; ETD>3500 N/mm2), and also good tear strengths (in MD>100 N/mm2; in TD>130 N/mm2).

Good orientability includes excellent capabilities of the film for orientation during its production, both longitudinally and transversely, without break-offs.

Cost-effective production conditions include the capability of the polymers, and of any other raw material components required for producing the low-flammability film, to be dried with commercially available industrial dryers such as vacuum dryers, fluidized-bed dryers or fixed-bed dryers (tower dryers). It is important that these raw materials do not cake or undergo thermal degradation. The dryers mentioned operate at temperatures of from 100 to 170° C., at which the expectations of the skilled worker are that flame-retardant polymers cake and the dryers and/or extruders become clogged to such a degree that the carbonized mass has to be removed, making film production impossible. In the vacuum dryer, which has the most gentle drying action, the polymer passes through a range of temperature of from about 30 to 130° C. at a pressure of 50 mbar. A process known as post drying is then required, in a hopper at temperatures of from 100-130° C. with a residence time of from 3 to 6 hours. Even here, the flame-retardant polymers prepared in accordance with the prior art cake to an extreme extent.

For the purposes of the present invention, no embrittlement on exposure to high temperature for a short period means that after 100 hours of heat treatment at 100° C. in a circulating-air drying cabinet the film has not embrittled and does not have poor mechanical properties.

The novel transparent film comprises, as principal constituent, a crystallizable thermoplastic. Examples of suitable crystallizable or semicrystalline thermoplastics are polyethylene terephthalate, polybutylene terephthalate and polyethylene naphthalate, preferably polyethylene terephthalate.

For the purposes of the present invention, crystallizable thermoplastics are crystallizable homopolymers, crystallizable copolymers, crystallizable compounds (mixtures), crystallizable recycled material and other types of crystallizable thermoplastics.

The transparent film may have either one layer or more than one layer. The transparent film may likewise have been coated with various coating agents, such as copolyesters, or adhesion promoters.

The novel film comprises at least one flame retardant, which is fed by way of what is known as masterbatch technology directly during production of the film, and the amount of flame retardant here is from 0.5 to 30.0% by weight, preferably from 1.0 to 20.0% by weight, based on the weight of the layer of the crystallizable thermoplastic. The ratio of flame retardant to thermoplastic is generally kept at from 60:40 to 10:90% by weight during preparation of the masterbatch.

Typical flame retardants include bromine compounds, chloroparaffins and other chlorine compounds, antimony trioxide, and alumina trihydrates, but the use of the halogen compounds here is disadvantageous due to the occurrence of halogen-containing byproducts. The low light resistance of films provided with these materials is moreover a great disadvantage, as is the evolution of hydrogen halides in the event of a fire.

Examples of suitable flame retardants used according to the invention are organic phosphorus compounds, such as carboxyphosphinic acids, anhydrides of these and dimethyl methylphosphonate. A substantive factor according to the invention is that the organic phosphorus compound is soluble in the thermoplastic, since otherwise the optical properties required are not complied with.

Since the flame retardants generally have some susceptibility to hydrolysis, the additional use of a hydrolysis stabilizer may be desirable.

The hydrolysis stabilizers used are generally amounts of from 0.01 to 1.0% by weight of phenolic stabilizers, the alkali metal/alkaline earth metal stearates and/or the alkali metal/alkaline earth metal carbonates. The amounts of phenolic stabilizers used are preferably from 0.05 to 0.6% by weight, in particular from 0.15 to 0.3% by weight, and their molar mass is preferably above 500 g/mol. Particularly advantageous compounds are pentaerythrityl tetrakis-3-(3,5-di-tert-butyl-4-hydroxyphenyl)propionate and 1,3,5-trimethyl-2,4,6-tris (3,5-di-tert-butyl-4-hydroxybenzyl)benzene.

The standard viscosity SV (DCA) of the polyethylene terephthalate, measured in dichloroacetic acid to DIN 53728, is from 600 to 1000, preferably from 700 to 900.

The transparent polyethylene terephthalate film which comprises at least one flame retardant may have one layer or else more than one layer. In the embodiment having more than one layer, the film has a structure of at least one core layer and at least one outer layer, and particular preference is given here to a three-layer structure of type A-B-A or A-B-C. A substantive factor for the embodiment having more than one layer is that the polyethylene terephthalate of the core layer has a standard viscosity similar to that of the polyethylene terephthalate of the outer layer(s) which is (are) adjacent to the core layer.

In one particular embodiment, the outer layers may also be composed of a polyethylene naphthalate homopolymer or of polyethylene terephthalate-polyethylene naphthalate copolymers, or of a compound. In this embodiment, the thermoplastics of the outer layers likewise have standard viscosities similar to that of the polyethylene terephthalate of the core layer.

In the embodiment having more than one layer, the flame retardancy is preferably present in the outer layer(s), however, the core layer may also have flame retardant, if required.

Unlike in the single-layer embodiment, the amounts given for the concentrations of flame retardant are based on the weight of the thermoplastics in the layer provided with the flame retardant.

Very surprisingly, fire-protection tests to DIN 4102 and the UL test showed that in the case of a three-layer film the provision of flame retardant in the outer layers of from 0.5 to 2 μm in thickness is fully sufficient to improve flame retardancy. If required and if fire-protection requirements are high, the core layer may also have what is known as a base-level flame retardant.

The low-flammability films having more than one layer and produced by known coextrusion technology are therefore of interest in economic terms when compared with monofilms fully provided with high concentrations of flame retardant, since markedly less flame retardant is needed.

There may also be provision, on at least one side of the film, of a scratch-resistant coating, a copolyester or an adhesion promoter.

During production of the film it was found that the low-flammability film can be produced using masterbatch technology and special predrying and/or precrystallization of the masterbatch (see process description) and by using small concentrations of hydrolysis stabilizer, without caking occurring in the dryer. In addition, no releases of gases and no deposits were found during the production process.

Furthermore, measurements showed that the novel film does not become brittle over a long period at high temperatures of 100° C., a fact which is more than surprising. This result is probably attributable to the synergistic action of suitable precrystallization, predrying, masterbatch technology and hydrolysis stabilizer.

The surface gloss, measured to DIN 67530 (measurement angle 20°), is above 100, preferably above 120, the luminous transmittance L, measured to ASTM D 1003, is above 80%, preferably above 82%, and the haze of the film, measured to ASTM S 1003, is below 20%, preferably below 15%. These are surprisingly good properties for the flame retardancy achieved.

The novel film can moreover readily be recycled without pollution of the environment and without loss of mechanical properties, and examples of uses for which it is suitable are therefore short-lived promotional placards, for constructing exhibition stands and for other promotional requisites where fire protection is desirable.

Surprisingly, even novel films in the thickness range from 5 to 300 μm comply with requirements for the construction materials classes B2 and B1 to DIN 4102 and with those for the UL 94 test.

An example of a production method for the novel, transparent, low-flammability film is extrusion on an extrusion line.

According to the invention, the flame retardant is fed by way of masterbatch technology. The flame retardant is fully dispersed in a carrier material. Carrier materials which may be used are the thermoplastic itself, e.g. the polyethylene terephthalate, or else other polymers compatible with the thermoplastic.

In masterbatch technology it is preferable for the particle size and the bulk density of the masterbatch to be similar to the particle size and the bulk density of the thermoplastic, so that homogeneous distribution is achieved, and with this uniform low flammability can be achieved.

The polyester films may be produced by known processes from a polyester with, if desired, other polymers and with the flame retardant and/or with other customary additives in customary amounts of from 1.0 to a maximum of 30% by weight, either in the form of a monofilm or else in the form of, if desired coextruded, films having more than one layer and with identical or differently constructed surfaces, where one surface may, for example, have been pigmented but no pigment is present at the other surface. Known processes may also have been used to provide one or both surfaces of the film with a conventional functional coating.

A substantive factor for the invention is that the masterbatch which comprises the flame retardant and, if used, the hydrolysis stabilizer, is precrystallized or predried. This predrying includes gradual heating of the masterbatch at reduced pressure (from 20 to 80 mbar, preferably from 30 to 60 mbar, in particular from 40 to 50 mbar), with agitation, and, if desired, post-drying at a constant, elevated temperature, again at reduced pressure. It is preferable for the masterbatch to be charged at room temperature from a metering vessel in the desired blend together with the polymer of the base and/or outer layers and, if desired, with other raw material components batchwise into a vacuum dryer in which the temperature profile moves from 10 to 160° C., preferably from 20 to 150° C., in particular from 30 to 130° C., during the course of the drying time or residence time. During the residence time of about 6 hours, preferably 5 hours, in particular 4 hours, the raw material mixture is stirred at from 10 to 70 rpm, preferably from 15 to 65 rpm, in particular from 20 to 60 rpm. The resultant precrystallized or predried raw material mixture is post-dried in a downstream vessel, likewise evacuated, at temperatures of from 90 to 180° C., preferably from 100 to 170° C., in particular from 110 to 160° C., for from 2 to 8 hours, preferably from 3 to 7 hours, in particular from 4 to 6 hours.

In the preferred extrusion process for producing the polyester film, the molten polyester material is extruded through a slot die and quenched on a chill roll, in the form of a substantially amorphous prefilm. This film is then reheated and stretched longitudinally and transversely, or transversely and longitudinally, or longitudinally, transversely and again longitudinally and/or transversely. In general, the stretching temperatures are from Tg+10° C. to Tg+60° C. (where Tg is the glass transition temperature), the longitudinal stretching ratio is usually from 2 to 6, in particular from 3 to 4.5, and the transverse stretching ratio is from 2 to 5, in particular from 3 to 4.5, and the ratio for any second longitudinal or transverse stretching carried out is from 1.1 to 5. The first longitudinal stretching may, if desired, be carried out simultaneously with the transverse stretching (simultaneous stretching). This is followed by the heat-setting of the film at oven temperatures of from 180 to 260° C., in particular from 220 to 250° C. The film is then cooled and wound up.

It was more than surprising, therefore, that by using masterbatch technology a suitable predrying and/or precrystallization procedure and, if desired, using small amounts of a hydrolysis stabilizer, it is possible to produce a low-flammability, thermoformable film with the required property profile in a cost-effective manner and without any caking in the dryer, and that on exposure to high temperature the film does not become brittle, and does not break when folded.

It was also very surprising that, together with this excellent result and with the flame retardancy required, within the accuracy of measurement, there is no adverse effect on the Yellowness Index of the film, compared with that of an unmodified film.

No releases of gases, no die deposits and no frame condensation were found, and the film therefore has excellent optical properties and excellent profile and layflat.

The novel low-flammability film has excellent stretchability, and can therefore be produced in a reliable and stable manner on high-speed film lines up to speeds of 420 m/min.

A film of this type is therefore also cost-effective.

It is also very surprising that the regrind can moreover be reused without any adverse effect on the Yellowness Index of the film.

The surprising combination of excellent properties makes the novel film highly suitable for a variety of different applications, such as interior decoration, for constructing exhibition stands, for exhibition requisites, for displays, for placards, for protective glazing of machines or vehicles, in the lighting sector, in fitting out shops or stores, or as a promotional requisite or laminating material, for greenhouses, roofing systems, exterior cladding, protective coverings, applications in the construction sector, illuminated advertizing profiles or blinds or electrical applications.

The examples below illustrate the invention in more detail.

The following standards and methods are used here when testing individual properties.

Test methods

Surface gloss

Surface gloss is measured with a measurement angle of 20° to DIN 67530.

Luminous transmittance

For the purposes of the present invention, the luminous transmittance is the ratio of total light transmitted to the amount of incident light.

Luminous transmittance is measured using “®HAZEGARD plus” test equipment to ASTM D 1003.

Haze

Haze is that percentage proportion of the transmitted light which deviates by more than 2.5° from the average direction of the incident light beam. Clarity is determined at an angle of less than 2.5°.

The haze is measured using “HAZEGARD plus” apparatus to ASTM D 1003.

Surface defects

Surface defects are determined visually.

Mechanical properties

The modulus of elasticity and tear strength at break are measured longitudinally and transversely to ISO 527-1-2.

SV (DCA) and IV (DCA)

The standard viscosity SV (DCA) is measured by a method based on DIN 53726 in dichloroacetic acid.

The intrinsic viscosity (IV) is calculated as follows from the standard viscosity (SV)

IV (DCA)=6.67·10−4 SV (DCA)+0.118

Fire performance

Fire performance is determined to DIN 4102, Part 2, construction materials class B2, and to DIN 4102, Part 1, construction materials class B1, and also by the UL 94 test.

### EXAMPLES

### Example 1

A transparent film of 50 μm thickness is produced, comprising polyethylene terephthalate as principal constituent, 0.2% by weight of silicon dioxide (Sylobloc) as antiblocking agent, 0.2% by weight of hydrolysis stabilizer and 4% by weight of flame retardant.

To obtain homogeneous distribution, the Sylobloc, which is insoluble in the PET, is incorporated into the polyethylene terephthalate when the polymer is prepared.

The polyethylene terephthalate from which the transparent film is produced has a standard viscosity SV (DCA) of 810, corresponding to an intrinsic viscosity IV (DCA) of 0.658 dl/g.

The hydrolysis stabilizer and the flame retardant are fed in the form of a masterbatch. The masterbatch is composed of 20% by weight of flame retardant, 1% by weight of hydrolysis stabilizer and 79% by weight of polyethylene terephthalate.

The hydrolysis stabilizer is pentaerythrityl tetrakis-3-(3,5-di-tert-butyl-4-hydroxyphenyl)propionate. The flame retardant is the organic phosphorus compound dimethyl methylphosphonate, _Amgard P 1045 from Albright & Wilson, which is soluble in PET. The masterbatch has a bulk density of 750 kg/m3 and a softening point of 69° C.

50% by weight of the polyethylene terephthalate, 30% by weight of recycled polyethylene terephthalate material and 20% by weight of the masterbatch are discharged at room temperature from separate metering vessels into a vacuum dryer which operates with a temperature profile of from 25 to 130° C. from the time of charging to the end of the residence time. During the residence time of about 4 hours, the mixture of raw materials is agitated at 61 rpm.

The precrystallized and/or predried mixture of raw materials is post-dried for 4 hours at 140° C. in a downstream hopper, again in vacuo. The 50 μm monofilm is then produced by the extrusion process described.

The transparent PET film produced has the following property profile:

| Thickness | | 50 μm |
|---|---|---|
| Surface gloss, | Side 1 | 155 |
| (Measurement angle 20°) | Side 2 | 152 |
| Luminous transmittance | | 91% |
| Haze | | 4.0% |
| Surface defects per m2 | | none |
| Longitudinal modulus of elasticity | | 4100 N/mm2 |
| Transverse modulus of elasticity | | 5400 N/mm2 |
| Longitudinal tear strength | | 170 N/mm2 |
| Transverse tear strength | | 260 N/mm2 |
| Yellowness Index (YID) | | 3.1 |

After 200 hours of heat treatment at 100° C. in a circulating-air drying cabinet there is no change in mechanical properties. The film shows no embrittlement phenomena of any kind. The film complies with the requirements for construction material classes B2 and B1 to DIN 4102 Part 2/Part 1. The film passes the UL 94 test.

### Example 2

Coextrusion technology is used to produce a multilayer PET film having the layer sequence A-B-A and a thickness of 17 μm, B being the core layer and A being the outer layers. The core layer has a thickness of 15 μm, and each of the two outer layers, which cover the core layer, has a thickness of 1 μm.

The polyethylene terephthalate used for the core layer B is identical with that of Example 1 except that it comprises no silicon dioxide (Sylobloc). The core layer comprises 0.2% by weight of hydrolysis stabilizer and 5% by weight of flame retardant. As in Example 1, the hydrolysis stabilizer and the flame retardant are fed in the form of a masterbatch. The masterbatch is composed of 25% by weight of flame retardant, 1% by weight of hydrolysis stabilizer and 74% by weight of polyethylene terephthalate. The hydrolysis stabilizer and the flame retardant are identical with those of Example 1.

The polyethylene terephthalate of the outer layer A is identical with polyethylene terephthalate of Example 1, that is to say the outer layer polymer has 0.3% by weight of Sylobloc. The outer layers comprise no hydrolysis stabilizer and no flame retardant.

For the core layer, 50% by weight of polyethylene terephthalate, 30% by weight of recycled polyethylene terephthalate material and 20% by weight of the masterbatch were precrystallized, predried and post-dried as in Example 1.

The outer layer polymer is not subjected to any particular drying. Coextrusion technology is used to produce a film having the layer sequence A-B-A and having a thickness of 17 μm and the following properties:

| Layer structure | | A-B-A |
|---|---|---|
| Total thickness | | 17 μm |
| Surface gloss, | Side 1 | 174 |
| (Measurement angle 20°) | Side 2 | 169 |
| Luminous transmittance | | 94.2% |
| Haze | | 2.1% |
| Surface defects | | none |
| (fish-eyes, orange peel, bubbles . . . ) | | |
| Longitudinal modulus of elasticity | | 4100 N/mm2 |
| Transverse modulus of elasticity | | 4720 N/mm2 |
| Longitudinal tear strength | | 180 N/mm2 |
| Transverse tear strength | | 205 N/mm2 |
| Yellowness Index (YID) | | 2.9 |

After 200 hours of heat treatment at 100° C. in a circulating-air drying cabinet there is no change in mechanical properties. The film shows no embrittlement phenomena of any kind.

The film complies with the requirements for construction material class B2 and B1 to DIN 4102 Part 2 and Part 1. The film passes the UL 94 test.

### Example 3

As in Example 2, a 20 μm A-B-A film was produced, the core layer B having a thickness of 16 μm and each outer layer A having a thickness of 2 μm.

The core layer B comprises only 5% by weight of the masterbatch of Example 2.

The outer layers are identical with those of Example 2, except that they comprise 20% by weight of the masterbatch, used in Example 2 only for the core layer.

The polymers and the masterbatch for the core layer and the outer layers are precrystallized, predried and post-dried as in Example 1.

The multilayer 20 μm film produced using coextrusion technology has the following property profile:

| Layer structure | | A-B-A |
|---|---|---|
| Total thickness | | 20 μm |
| Surface gloss, | Side 1 | 168 |
| (Measurement angle 20°) | Side 2 | 163 |
| Luminous transmittance | | 94.0% |
| Haze | | 2.2% |
| Surface defects | | none |
| (fish-eyes, orange peel, bubbles . . . ) | | |
| Longitudinal modulus of elasticity | | 4000 N/mm2 |
| Transverse modulus of elasticity | | 4700 N/mm2 |
| Longitudinal tear strength | | 180 N/mm2 |
| Transverse tear strength | | 205 N/mm2 |
| Yellowness Index (YID) | | 2.9 |

After 200 hours of heat treatment at 100° C. in a circulating-air drying cabinet there is no change in mechanical properties. The film shows no embrittlement phenomena of any kind.

The film complies with the requirements for the construction material classes B2 and B1 to DIN 4102 Part 2 and Part 1. The film passes the UL 94 test.

### Comparative Example 1

Example 2 is repeated, except that the film is not provided with masterbatch, that is to say the film comprises no hydrolysis stabilizer and no flame retardant.

The property profile of the film without these additives is comparable with that of the film of Example 2, which has these additives.

The film without these additives does not pass the tests to DIN 4102 Part 1 and Part 2 or the UL 94 test.

What is claimed is:

1. A transparent polyester film comprising at least one flame retardant which is soluble in the polyester and is fed directly by way of masterbatch technology during film production, where the masterbatch was obtained by gradual heating at subatmospheric pressure, with stirring.

2. The polyester film as claimed in claim 1, wherein the film comprises a hydrolysis stabilizer.

3. The polyester film as claimed in claim 1, wherein the gradual heating at subatmospheric pressure, with stirring, is directly followed by drying at constant, elevated temperature, likewise at subatmospheric pressure.

4. The polyester film as claimed in claim 1, wherein the flame retardant is selected from one or more organic phosphorus compounds.

5. The polyester film as claimed in claim 2, wherein the hydrolysis stabilizer is selected from the group consisting of phenolic hydrolysis stabilizers, alkali metal/alkaline earth metal stearates and/or alkali metal/alkaline earth metal carbonates.

6. The polyester film as claimed in claim 1, wherein the film comprises from 0.5 to 30.0% by weight of flame retardant.

7. The polyester film as claimed in claim 2, wherein the film comprises from 0.1 to 1.0% by weight of hydrolysis stabilizer.

8. The polyester film as claimed in claim 1 or 2, wherein the film has two or more layers and comprises a base layer and at least one outer layer.

9. The polyester film as claimed in claim 8, wherein the flame retardant is present in the outer layer.

10. The polyester film as claimed in claim 9, wherein from 0.5 to 30% by weight (based on the weight of the outer layer) of the flame retardant is present in the outer layer.

11. The polyester film as claimed in claim 8, wherein the hydrolysis stabilizer is present in the outer layer.

12. The polyester film as claimed in claim 11, wherein from 0.1 to 1.0% by weight (based on the weight of the respective outer layer) of the hydrolysis stabilizer is present in the outer layer.

13. The polyester film as claimed in claim 1, wherein the film comprises recycled material.

14. The polyester film as claimed in claim 1, wherein the film has a surface gloss, measured according to DIN 67530 (measurement angle 20°), of greater than 100.

15. The polyester film as claimed in claim 1, wherein the film has a luminous transmittance L, measured according to ASTM D 1003, of more than 80%.

16. The polyester film as claimed in claim 1, wherein the haze of the film, measured according to ASTM D 1003, is less than 20%.

17. The polyester film as claimed in claim 1, wherein the film has a Yellowness Index of<10.

18. A process for producing the polyester film as claimed in claim 1, in which a polyester melt is fed to an extrusion die, or to produce a film having two or more layers, polyester melts corresponding to the compositions of the outer and base layers are fed to a coextrusion die, and extruded from the die onto a chill roll, and the resultant prefilm is then biaxially oriented and heat-set, where the polyester comprises at least one flame retardant which is soluble in the polyester and which is fed directly by way of masterbatch technology during film production, and where the masterbatch was obtained by gradual heating at subatmospheric pressure, with stirring.
